(19) United States
(12) Patent Application Publication
(10) Pub. No.: US 2026/0009482 A1
(43) Pub. Date: Jan. 8, 2026

(54) FLUID COUPLERS AND RELATED SYSTEMS AND METHODS

(71) Applicant: CoolIT Systems, Inc., Calgary (CA)

(72) Inventors: Mohammad Reza Najjari, Calgary (CA); Seyed Kamaleddin Mostafavi Yazdi, Calgary (CA)

(21) Appl. No.: 19/256,986

(22) Filed: Jul. 1, 2025

Related U.S. Application Data
(63) Continuation-in-part of application No. 17/689,879, filed on Mar. 8, 2022.
(60) Provisional application No. 63/666,642, filed on Jul. 1, 2024.

(51) Int. Cl. F16L 27/08; F28F 9/02

(52) U.S. Cl. CPC F16L 27/0804; F28F 9/0256

(57) ABSTRACT

A fluid coupler for coupling a conduit to a component, e.g., a cold plate, has a sealed swivel joint between a component coupler configured to be fixedly attached to the component and a conduit coupler configured to be fixedly attached with the conduit. The swivel joint can comprise a press or snap fit coupling between the component coupler and the conduit coupler. A sealing member can be so positioned as to inhibit leakage of a fluid from the swivel joint. A heat-transfer component (e.g., a cold plate) or other component of a liquid cooling system can incorporate a fluid coupler having a swivel joint.

### CROSS-REFERENCE TO RELATED APPLICATIONS

This application claims benefit of and priority from pending U.S. Patent Application No. 63/666,642, filed Jul. 1, 2024, and is a continuation-in-part of co-pending U.S. patent application Ser. No. 17/689,879, filed Mar. 8, 2022, the contents of which patent applications are hereby incorporated in their entirety as if fully reproduced herein, for all purposes.

### FIELD

This application and the subject matter disclosed herein (collectively referred to as the “disclosure”), generally concern fluid couplers, and related fluid connectors, systems and methods, such as, for example, as disclosed in pending U.S. Patent Application Publication No. 2023/0288000, published Sep. 14, 2023, the contents of which are hereby incorporated in their entirety as if fully reproduced herein, for all purposes. More particularly, but not exclusively, this disclosure pertains to rotatable fluid couplers, as well as fluid connections and other devices incorporating such couplers, together with methods of making and using such couplers.

### BACKGROUND INFORMATION

New generations of electronic components, such as, for example, memory components, microprocessors, graphics processors, application specific integrated circuits (ASICs), hard drives, and power electronics semiconductor devices, produce increasing amounts of heat when operating. In addition, electronic devices, such as, for example, servers, computers, game consoles, power electronics, communications and other networking devices, batteries, and so on, arrange electronic components in close proximity with each other. If the heat generated by operating such components is not removed from such devices at a sufficient rate, the components can overheat, decreasing their performance, reliability, or both, and in some cases such overheating can result in outright component damage or failure.

The prior art has addressed these challenges using air cooling, liquid cooling (e.g., involving liquid coolant, e.g., water, glycol, polyethylene glycol, etc.), or a combination thereof, to transfer and dissipate heat from electronic components to an ultimate heat sink, e.g., the atmosphere.

Conventional air cooling relies on natural convection or uses forced convection (e.g., a fan mounted near a heat producing component) to replace heated air with cooler ambient air around the component. Such air-cooling techniques can be supplemented with a conventional “heat sink,” which often is a plate of a thermally conductive material (e.g., aluminum or copper) placed in thermal contact with the heat-producing component. The heat sink can spread heat from the component to a larger area for dissipating heat to the surrounding air. Some heat sinks include “fins” to further increase the surface area available for heat transfer and thereby to improve the transfer of heat to the air. Some heat sinks include a fan to force air among the fins and are commonly referred to in the art as “active” heat sinks.

Liquid cooling improves cooling performance compared to air cooling techniques described above, as many liquids, e.g., water, have significantly better heat transfer capabilities than air. FIG. 1 illustrates various components of a liquid cooling loop 100. The cooling loop 100 typically operates by (1) transferring heat, Q in, from a heat-generating electronic component (not shown) to a cool liquid passing through a heat exchanger 110 (sometimes referred to in the art as a “cold plate” or a “heat sink”) placed in thermal contact with the heat-generating component, (2) transporting the heat absorbed by the liquid (which may remain a sub-cooled liquid or may become during the heating a saturated mixture of liquid- and gas-phase, or may be entirely in a gas-phase) to a remote radiator 120, or heat rejector (sometimes referred to in the art generally as a “heat exchanger,” or a “liquid-to-liquid heat exchanger” if the heat is rejected to another liquid or a “liquid-to-air heat exchanger” if the heat is rejected to air), (3) rejecting the heat, Qₒᵤₜ, from the heated liquid (which may enter in a liquid-phase, a gas-phase, or a mixture thereof) with a remote radiator to another medium (e.g., air or facility water passing through the remote radiator), and (4) returning cooled liquid to the heat exchanger (or heat sink). Many heat exchangers for removing heat generated by such components have been proposed. As but one example, device-to-liquid heat exchangers have been proposed, as for example in U.S. patent application Ser. No. 12/189,476 and related patent applications, and in other patent applications (e.g., U.S. Patent Application No. 63/635,593, filed Apr. 17, 2024, U.S. Patent Application No. 61/794,698, filed Mar. 15, 2013). Each of the foregoing disclosures is hereby incorporated by reference as fully as if recited herein in its entirety, for all purposes.

As indicated in FIG. 1, one or more conduits convey the fluid between and among the foregoing components. A fluid coupler couples each conduit with the corresponding components to facilitate movement of the fluid (e.g., in a liquid-phase) between the respective conduit and each corresponding component.

### SUMMARY

In some respects, concepts disclosed herein generally concern fluid couplers, and related fluid connectors, systems and methods. More particularly, but not exclusively, disclosed principles pertain to rotatable fluid couplers, fluid connections incorporating such couplers, and methods of making, installing and using such couplers. Some embodiments of disclosed principles provide fluid couplers that are physically smaller than prior fluid couplers while providing equally or more reliable fluid connections (e.g., fluid connections relatively less susceptible to leaking than prior connections). Such diminutive fluid couplers allow for more flexibility when designing other cooling-system components because, for example, less of the limited space around heat-generating components is occupied by the fluid couplers.

Further, fluid couplers embodying disclosed principles provide additional advantages over prior-art couplers. For example, some disclosed principles enable rotatable fluid connections (e.g., the coupler or a portion thereof can swivel relative to a component). Also, some disclosed principles enable automated installation and assembly of disclosed couplers with a component. And, some disclosed principles provide one or more further advantages, such as, for example, relatively higher compression on O-rings (or other seals or gaskets) than prior couplers provide, enhancing reliability of the fluid connection provided by the coupler. Further, some disclosed fluid couplers require less depth in a component or less component material than prior couplers to gain purchase in or with the component, as when assembling such couplers with the component.

According to a first aspect, a fluid coupler having a swivel joint includes a component coupler, a conduit coupler and a sealing member.

The component coupler extends from a first end to a second end and defines an internal bore extending from the first end to the second end. The internal bore of the component coupler has a longitudinal axis. The component coupler defines a component coupling adjacent the first end. The component coupling is configured to matingly engage with another component to secure the fluid coupler with the other component and to fluidically couple the internal bore of the component coupler with a corresponding internal passageway defined by the other component. The component coupler defines a first portion of a press or snap fit coupling positioned adjacent the second end.

The conduit coupler extends from a first end to a second end and defines an internal bore extending from the first end to the second end. The internal bore of the conduit coupler has a longitudinal axis. The conduit coupler defines a conduit coupling adjacent the second end of the conduit coupler. The conduit coupling is configured to matingly engage with a conduit to secure the fluid coupler with the conduit and to fluidically couple the internal bore of the conduit coupler with a corresponding internal passageway defined by the conduit. The conduit coupler defines a second portion of the press or snap fit coupling adjacent the first end of the conduit coupler.

The first portion of the press or snap fit coupling and the second portion of the press or snap fit coupling are pressed or snap fit together to define the swivel joint. The sealing member is so positioned as to inhibit leakage of a fluid from the swivel joint.

For example, the first portion of the press or snap fit coupling can include a shoulder extending laterally outward relative to the longitudinal axis of the internal bore of the component coupler. The internal bore of the conduit coupler can define an internal wall. The second portion of the press or snap fit coupling can be a recessed channel defined by the internal wall. The recessed channel can extend laterally outward relative to the longitudinal axis of the internal bore of the conduit coupler. An O-ring can be positioned in the recessed channel, the recessed channel can retain the laterally outward shoulder of the component coupler, and the O-ring can seals against the shoulder, thereby defining a sealed swivel joint. Although the laterally outward shoulder has just been described as a portion of the component coupler and the recessed channel has just been described as a portion of the conduit coupler, the component coupler can define such a recessed channel and the conduit coupler can define the laterally outward shoulder. As well, other press or snap fit connection configurations between the component coupler and the conduit coupler are possible.

The internal bore of the component coupler can aligns with the internal bore of the conduit coupler across the swivel joint of the fluid coupler.

The component coupling can include a piston configured to extend into the other component and a recessed groove configured to receive a pin to capture the piston within the other component.

The component coupling can define a threaded region configured to matingly engage with a complementary thread defined by the other component.

The component coupling can define a piston defining the first end of the component coupler. In some embodiments, the component coupling further defines a channel positioned between the first end of the component coupler and the second end of the component coupler. The sealing member can be a first sealing member and the channel can be configured to capture a second sealing member between the component coupler and the other component when the fluid coupler is secured with the other component. One or both of the first sealing member and the second sealing member can be an O-ring.

In some embodiments, the channel positioned between the first end of the component coupler and the second end of the component coupler is an annular recess extending around the component coupler.

One of the first portion of the press or snap fit coupling and the second portion of the press or snap fit coupling can include an external shoulder, and the other one of the first portion of the press or snap fit coupling and the second portion of the press or snap fit coupling can include an internal shoulder. In some embodiments, the one of the first portion of the press or snap fit coupling and the second portion of the press or snap fit coupling that includes the external shoulder further defines an external tapered surface extending from the external shoulder.

In some embodiments, the one of the first portion of the press or snap fit coupling and the second portion of the press or snap fit coupling that comprises the internal shoulder further defines an internal tapered surface extending from the internal shoulder. In some embodiments, the other one of the first portion of the press or snap fit coupling and the second portion of the press or snap fit coupling that includes the internal shoulder defines an internal channel defining the internal shoulder, wherein the external shoulder is positioned in the internal channel with the external shoulder and the internal shoulder being in opposed relation to each other. In some embodiments, the sealing member is captured in the channel and urges against corresponding regions of the first portion of the press or snap fit coupling and the second portion of the press or snap fit coupling. The sealing member can be an O-ring.

The conduit coupling can define a barbed connection for securing conduit with the fluid coupler.

According to another aspect, a heat-transfer component includes a housing, a heat-transfer interface, and a fluid coupler.

The housing defines an inlet, an outlet, and a passageway for conveying fluid from the inlet to the outlet. The heat-transfer interface is configured to be placed in thermal contact with a heat-generating component. A segment of the passageway extends across a portion of the heat-transfer interface to facilitate transfer of heat from the heat-generating component to the fluid passing through the segment of the passageway. The fluid coupler has a first portion fixedly secured with the housing. The first portion defines an internal bore opening to the inlet or the outlet defined by the housing. The fluid coupler has a second portion defining an internal bore aligned with the internal bore of the first portion. The fluid coupler defines a swivel joint between the first portion and the second portion to permit the second portion to pivot relative to the first portion. The fluid coupler further has a sealing member within the swivel joint to inhibit leakage of the fluid from the swivel joint.

The first portion can define a first threaded region and the housing can define a corresponding second threaded region matingly engaged with the first threaded region to fixedly secure the first portion of the fluid coupler with the housing.

According to another aspect, a liquid cooling system for cooling a heat-generating component includes a pump, a cold plate, a first conduit, a second conduit, a fluid coupler and a heat exchanger.

The pump is configured to urge a liquid coolant through the liquid cooling system. The cold plate has an internal passageway configured to convey the liquid coolant through the cold plate and to facilitate heat transfer from the heat-generating component to the liquid coolant as the liquid coolant passes through the cold plate. The first conduit defines an internal passageway configured to convey the liquid coolant to the cold plate and a second conduit defining an internal passageway configured to convey the liquid coolant from the cold plate. The fluid coupler has a first portion fixedly secured with the cold plate. The first portion defines an internal bore opening to internal passageway of the housing. The fluid coupler has a second portion defining an internal bore aligned with the internal bore of the first portion. The fluid coupler defines a swivel joint between the first portion and the second portion to permit the second portion to pivot relative to the first portion. The fluid coupler further has a sealing member within the swivel joint to inhibit leakage of the fluid from the swivel joint. One of the first conduit and the second conduit is so coupled with the second portion of the fluid coupler as to align the respective internal passageway with the internal bore of the second portion. The heat exchanger is configured to reject heat absorbed by the liquid coolant in the cold plate to another medium.

In some embodiments, the first portion defines a first threaded region and the cold plate defines a corresponding second threaded region matingly engaged with the first threaded region to fixedly secure the first portion of the fluid coupler with the cold plate.

In some embodiments, the swivel joint includes a press or snap fit connection between the first portion of the fluid coupler and the second portion of the fluid coupler.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 illustrates a closed liquid cooling loop.

FIG. 2 illustrates an exploded view of a prior-art fluid coupling between a heat-transfer component and a prior-art fluid coupler.

FIG. 3 illustrates an embodiment of a cold-plate assembly incorporating a plurality of fluid couplers that couple a conduit with a component. In FIG. 3, the fluid couplers optionally incorporate swivel joints as disclosed herein.

FIG. 4 shows a partial cross-sectional view of a fluid coupler having a swivel joint.

FIG. 5 shows an exploded view, in partial cross-section, of a fluid coupler generally as in FIG. 4. The fluid coupler has a component coupler and a conduit coupler that join together at a swivel interface.

FIGS. 6 to 15 show further alternative embodiments of a fluid coupler having a swivel joint between a component coupler and a conduit coupler.

### DETAILED DESCRIPTION

The following describes various principles pertaining to fluid couplers, and related fluid connectors, systems and methods. That said, descriptions herein of specific apparatus configurations and combinations of method acts are but particular examples of the variety of contemplated embodiments, chosen as being convenient to illustrate disclosed principles. One or more of the disclosed principles can be incorporated in various other embodiments to achieve any of a variety of corresponding system characteristics.

Thus, embodiments of disclosed principles having attributes that are different from those specific embodiments discussed herein can embody one or more presently disclosed principles and can be used in applications not described herein in detail. Accordingly, such alternative embodiments also fall within the scope of this disclosure.

Embodiments of disclosed fluid couplers, and related fluid connectors, systems and methods can be incorporated in a wide variety of fluidic devices and systems to improve reliability of fluidic connections between components compared to prior-art fluid couplers. Further, disclosed fluid couplers have a less-complex physical geometry compared to prior-art fluid couplers and can thus readily be manufactured using existing machining, molding or casting techniques. To enhance apprehending the significance of presently disclosed fluid couplers, the following provides a brief overview of prior fluid couplers and several corresponding long-felt but unmet needs associated with them.

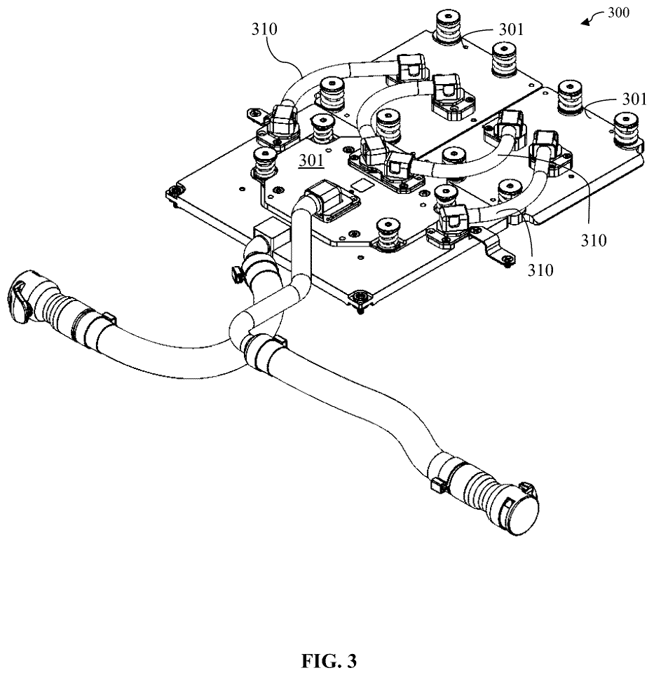

FIG. 2 shows an exploded view of a fluid assembly including a housing 10 for a cooling device and two prior art fluid couplers 20. U.S. Pat. No. 10,274,266, issued Apr. 30, 2019, describes such cooling devices and is hereby incorporated in its entirety for all purposes to the same extent as if fully reproduced herein.

Referring still to FIG. 2, the housing 10 defines a pair of sockets 11, each being configured to receive an insertable piston 24 defined by one of the fluid couplers 20. As shown, each piston 24 extends distally away from a body portion 25 and defines several longitudinally spaced-apart, annular ribs 21 that define annular gaps (or grooves) 23, 43 therebetween. The fluid couplers 20 have hollow interiors through which fluid (e.g., a liquid-phase, a gas-phase, or a saturated mixture thereof) can pass. In the illustrated devices, an internal bore extends from a proximal end of the conduit shank 22 to a distal end of the piston 24, allowing fluid to pass from the distal end to the proximal end, and vice-versa.

More specifically, each piston 24 defines a proximal rib 21a spaced apart from the body 25, defining a proximal annular gap (or groove) 43 positioned between a distally oriented face (not shown) of the body and a proximally oriented face of the proximal rib 21a. Further, each piston 24 defines a second (medial) rib 21b distally spaced apart from the proximal rib 21a, defining a medial annular gap (or groove) 23 positioned between a distally oriented face (not shown) of the proximal rib 21a and a proximally oriented face of the medial rib 21b. The medial annular gap defines a gland for a first O-ring 30, which can be seated in the medial gap between the proximal and medial ribs 21a, 21b. Still further, each piston 24 defines a third (distal) rib 21c distally spaced apart from the medial rib 21b, defining a distal annular gap (or grove) 23 positioned between a distally oriented face (not shown) of the medial rib 21b and a proximally oriented face of the distal rib 21c. The distal annular gap similarly defines a gland for a second O-ring 30, which can be seated in the distal gap between the medial and distal ribs 21b, 21c.

Each coupler 20 also has a conduit shank 22 extending from the body portion 25 for engaging a fluid conduit (not shown). The conduit shank 22 also defines a plurality of external barbs 221 that resist axial sliding of the fluid conduit (not shown) away from the body portion 25 after the shank 22 is inserted into the conduit. The shank 22 defines an internal bore (not shown) providing a first segment of a fluid passage through the coupler 20. As well, the body portion 25 and the piston 24 define a second segment of the fluid passage through the coupler.

When the piston 24 is inserted into a corresponding socket 11, the bore through the piston fluidically couples with an internal fluid passage defined by the housing 10. Further, the O-rings urge against an interior surface 111 of the socket, compressing into the gland and sealing against one or more of the surfaces defining the annular gap. Further, a bore 42 defined by the housing can align with and extend transversely relative to the proximal gap 43. A pin 41 inserted into the bore 42 can thus extend transversely through the proximal gap 43 between the distally oriented face of the body portion and the proximally oriented face of the proximal rib 21a. The pin 41 thusly inserted through the gap 43 can inhibit translation (e.g., further insertion or withdrawal) of the piston 24 relative to the socket 11, as the proximally-oriented face of proximal rib 21a will urge against the pin 41 as a withdrawal force is applied to the coupler 20 and the distally-oriented face of the body portion 25 will urge against the pin 41 as an insertion force is applied to the coupler 20. Nonetheless, the arrangement of the pin 41 within the annular gap 43 will permit the coupler 20 to rotate around a longitudinal axis of the piston 24.

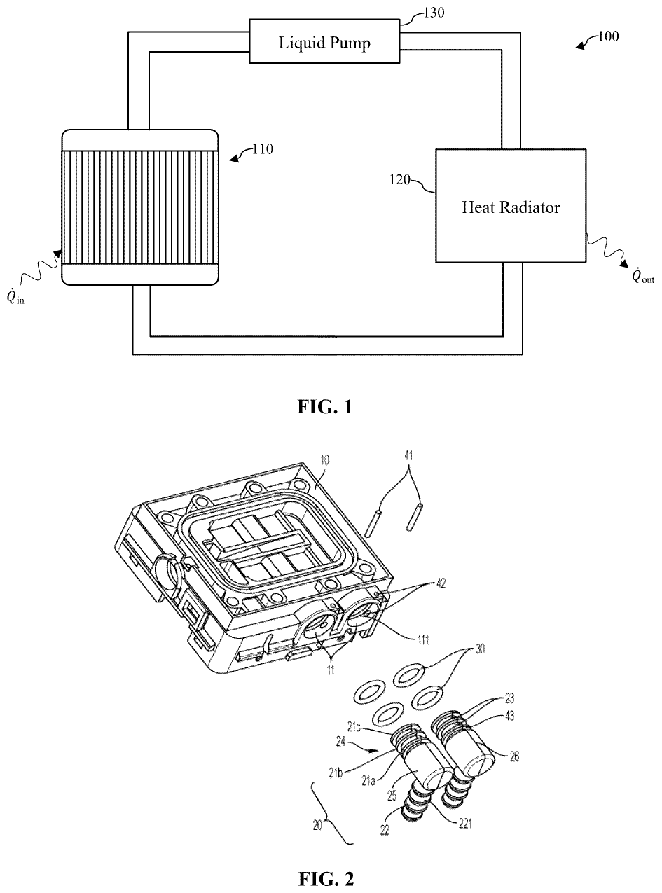

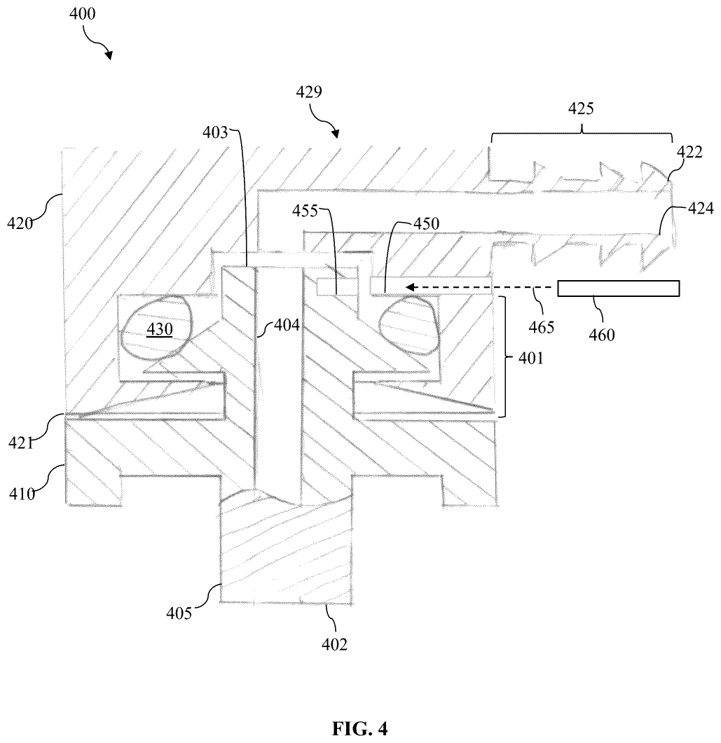

Referring again to the schematic illustration in FIG. 1, a cooling system can substitute an assembly of one or more cold plates and a thermal transfer plate, e.g., as shown in FIG. 3, for the heat exchanger 110. Assemblies having one or more cold plates and/or a thermal transfer plate, as in FIG. 3, are described more fully in one or more of co-pending U.S. Patent Application Ser. No. 63/635,593, filed Apr. 17, 2024, U.S. Patent Application Ser. No. 63/633,584, filed Apr. 12, 2024, and U.S. Patent Application Ser. No. 63/575,623, filed Apr. 6, 2024, each of which applications is hereby incorporated in its entirety as completely as if recited herein in full, for all purposes. Alternatively, such an assembly of one or more cold plates and a thermal transfer plate can be added to a cooling loop of the type depicted in FIG. 1. For example, the heat exchanger 110 shown in FIG. 1 may be placed in thermal contact with a processing component, and an assembly of one or more cold plates and a thermal transfer plate can be fluidically coupled (in series or in parallel) with the heat exchanger 110. On reviewing this disclosure, a person of ordinary skill in the art will understand and appreciate the various modifications to fluid connections, pumping resources, and radiator configurations that such alternative arrangements could or would require in order to urge a sufficient flow of coolant through each heat exchanger/heat-exchanger assembly in a given cooling loop, as well as to reject absorbed heat from the coolant to another cooling medium.

Such cooling systems also can include a heat radiator, e.g., the radiator 120, configured to reject heat from the liquid coolant to another medium as the liquid coolant passes through the heat radiator, generally as described above in connection with FIG. 1. Such cooling systems also include a pump configured to urge the liquid coolant throughout a closed loop.

A cooling system as just described can be installed in or on an electronic device to cool a multi-chip module, or another plurality of heat-generating components operably assembled with a motherboard or an add-in card, alone or in combination with other heat-generating components e.g., memory components, memory controllers, processing units, power delivery devices, EEPROMs, etc. Moreover, a given electronic device, e.g., a server or a rack of servers, may have a plurality of motherboards, add-in cards, or modules, having operably mounted therewith a plurality of such heat-generating components, with each motherboards, add-in cards, or modules being cooled by an assembly of cold plates and thermal transfer plate.

As FIG. 2 indicates, a fluid coupler 20 can be used to fluidically couple a conduit with a heat exchanger 110 and/or a heat radiator 120 as in FIG. 1. The fluid coupler 20 can alternatively be used to fluidically couple a conduit with a cold plate in an assembly, e.g., as in FIG. 3 and/or in one or more co-pending patent applications herein incorporated. Fluid couplers described herein also or alternatively can be used to fluidically couple a conduit with a heat exchanger 110 and/or a heat radiator 120 as in FIGS. 1 and 2. However, unlike prior fluid couplers that had a fixed arrangement between opposed ends, disclosed fluid couplers provide an intermediate swivel joint allowing one portion of the coupler to be fixedly secured to another component while still allowing another portion, e.g., a conduit coupler, to pivot relative to the fixedly secured portion of the coupler.

A fluid coupler as disclosed herein can alternatively be used to fluidically couple a conduit with a cold plate in an assembly, e.g., a cold plate as in FIG. 3 and/or in one or more co-pending patent applications herein incorporated. For example, a coupler described herein can be embodied or used as a “turret” configured to couple a conduit to a cold plate or other heat-exchanging device as described in one or more co-pending patent applications herein incorporated. FIG. 3 shows an example of a cold-plate assembly 300 having a plurality of cold-plates 301 fluidically coupled with each other by conduits 310. Each conduit, in turn, can be coupled with one or more cold plates with a presently disclosed coupler 320. However, instead of being secured to the cold plate 301 by a pin or a clip, as with couplers shown and described in relation to FIG. 2 herein or as with turrets disclosed in those other applications, disclosed fluid couplers 320 can be coupled to a component (e.g., cold plate 301) to provide, for example, a swivel connection.

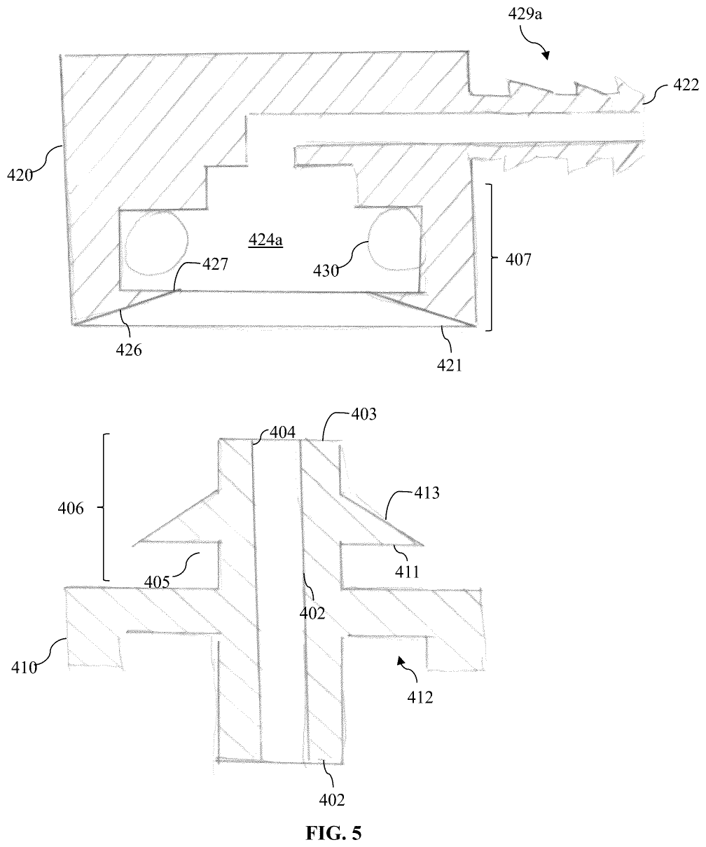

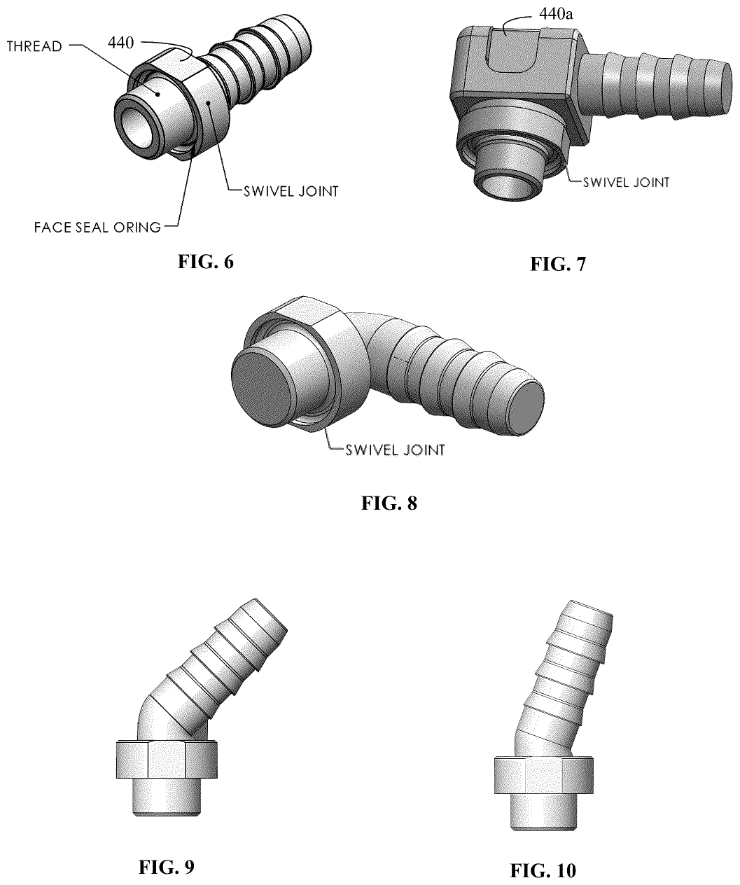

For example, referring now to FIG. 4, a fluid coupler 400 having a swivel joint 401 is described. The fluid coupler 400 has a component coupler 410 extending from a first end to a second end 403 and defining an internal bore 404 extending from the first end to the second end. The internal bore 403 of the component coupler has a longitudinal axis. The component coupler 401 defines a component coupling 405 adjacent the first end. The component coupling 405 is configured to matingly engage with another component (e.g., a cold plate 301 as in FIG. 3) to secure the fluid coupler 400 with the other component and to fluidically couple the internal bore 404 of the component coupler with a corresponding internal passageway defined by the other component. The component coupler 410 defines a first portion 406 (FIG. 5) of a press or snap fit coupling positioned adjacent the second end 403.

Referring again to FIG. 4, a conduit coupler 420 extends from a first end 421 to a second end 422 and defines an internal bore 424 extending from the first end to the second end. The internal bore 424 of the conduit coupler has a longitudinal axis. The conduit coupler 420 defines a conduit coupling 425 adjacent the second end 422 of the conduit coupler. The conduit coupling 420 is configured to matingly engage with a conduit (e.g., a conduit 310 in FIG. 3) to secure the fluid coupler with the conduit and to fluidically couple the internal bore 424 of the conduit coupler with a corresponding internal passageway defined by the conduit. The conduit coupler 420 defines a second portion 407 of the press or snap fit coupling 401 adjacent the first end 421 of the conduit coupler. A sealing member 430 is so positioned as to inhibit leakage of a fluid from the swivel joint 401. With embodiments as in FIGS. 4 and 5, the first portion 406 of the press or snap fit coupling and the second portion 407 of the press or snap fit coupling can be pressed or snap fit together to define the swivel joint 401.

In some swivel joint embodiments, e.g., embodiments as shown in FIGS. 4 and 5, a threaded stud can threadably engage with a complementary threaded recess defined by a component, e.g., a cold plate 301 (FIG. 3) to which the conduit 310 is being coupled. A swivel member (e.g., a conduit coupler 420) can pivotably engage with a portion of the swivel coupler defining the threaded stud, defining a swivel connection between the swivel member and the threaded stud, and thus between the conduit (e.g., conduit 310) and the component (e.g., cold plate 301). For example, the swivel member can be press-fit on or with a component coupler that defines such a threaded stud or other component coupling 405.

In another embodiment, the component (e.g., a cold plate) can define a boss or other stud that a disclosed swivel member pivotably engages, defining another embodiment of a swivel connection. For example, a housing of a cold plate can define a component coupler 420 and the swivel member (e.g., a conduit coupler 420) can be press-fit with such component coupler. In still other embodiments, a pivotable member can define a stud that pivotably engages a corresponding recess defined by the component, defining a swivel connection. For example, a housing of a cold plate 301 can define a recessed region having a configuration similar to the recessed interior of the conduit coupler 420 shown in FIG. 5. A conduit coupler, in turn, can define a studded portion similar to the shoulder 411 and mating surface of the component coupler 410 shown in FIG. 5, and such studded portion can press-fit into or with the complementary recess defined by the housing. In each case, the disclosed swivel connection between components that are pivotably engaged with each other omits pins or clips, e.g., pins or clips as described for example in connection with FIG. 2, above, and/or one or more of co-pending U.S. Patent Application Ser. No. 63/635,593, filed Apr. 17, 2024, U.S. Patent Application Ser. No. 63/633,584, filed Apr. 12, 2024, and U.S. Patent Application Ser. No. 63/575,623, filed Apr. 6, 2024, and U.S. patent application Ser. No. 17/689,879, filed Mar. 8, 2022.

FIGS. 4 and 5 illustrate an embodiment of a fluid coupler 400 having a swivel connection 401 between a conduit coupler 420 and a component coupler 410. FIG. 4 shows the assembled fluid coupler 400 in partial cross-section and FIG. 5 shows an exploded view of the fluid coupler. In FIG. 4, a proximal region of the component coupler defines an externally threaded stud 405 suitable for engaging with a complementary internal thread defined by, for example, a recess in a cold-plate housing. An annular, recessed groove 412 facing the proximal end 402 of the component coupler 410 can receive a sealing gland, e.g., an O-ring, and provide a sealing surface. For example, when the threaded stud 405 engages a component housing, the O-ring can be captured between an external surface of the housing and the interior surface of the annular recess 412. As the threaded stud 405 engages the housing more deeply, the O-ring can be compressed and fill the recess 412, providing a liquid-tight seal.

A distal region 406 (FIG. 5) of the component coupler 420 can be configured to pivotably couple with a conduit coupler 410. An internal bore 404 extending from the proximal end 402 adjacent the thread to the distal end 403 adjacent the taper 413 can define an internal passageway for conveying a liquid or other fluid. The proximal end of the bore can align with and thus couple the passageway through the component coupler 410 with a bore or passageway defined by the component, e.g., cold plate 301. As FIG. 5 shows, a distal portion of the component coupler 410 can define an interface coupling suitable for pivotably engaging with a conduit coupler 420 in a sealing (e.g., a liquid-tight) arrangement under anticipated ambient conditions and internal pressures. For example, the distal end 403 can define a taper 413 and an undercut shoulder 411 suitable for coupling with the conduit coupler 420 through a press-fit assembly procedure.

Still with reference to FIG. 5, a proximal region 407 of the conduit coupler 420 can define an internal bore 424 and an internally tapered surface 426 also defining an internal shoulder 427. The internally tapered surface 426 of the conduit coupler 420 can facilitate a press-fit assembly with the tapered distal end of the component coupler 410. An internal, circumferentially extending groove 428 can define a sealing surface and receive a gland 430, e.g., an O-ring. As the tapered distal end of the component coupler 410 passes into the proximal bore 424a of the conduit coupler 420 and past the internally tapered surface 426 thereof, the undercut shoulder 411 of the component coupler 410 can come into an opposed facing relation to the shoulder 427 defined by the internally tapered surface 426, which also corresponds to a proximal surface of the internal, circumferentially extending groove 428 defined by the proximal region of the conduit coupler 420. When the shoulders 427, 411 of the conduit coupler and the component coupler, respectively, are in opposed facing relation to one another (as in FIG. 4), the proximal end of the conduit coupler 420 can capture the distal end of the component coupler 410, providing a longitudinally inseparable but pivotable coupling 401 between the conduit coupler and the component coupler.

As FIG. 4 shows, the internal bore 424 defined by the conduit coupler 420 can align with the internal bore 404 of the component coupler 410, fluidically coupling the bores with each other and thus fluidically coupling the bore of the conduit coupler with an internal passageway defined by the component to which the component coupler may ultimately be coupled. With such a swivel joint, the O-ring 430 sealably engages with the tapered surface 413 of the component coupler 410 as well as the internal surfaces of the internal, circumferentially extending groove 428 defined by the proximal region of the conduit coupler 420. The conduit coupler 420 can also define a barbed connector 429a for coupling with a conduit. As FIG. 5 shows, the internal passageway defined by the conduit coupler 420 can bend through an angle, e.g., a 90-degree bend, a 75-degree bend, a 60-degree bend, a 45-degree bend, a 30-degree bend or 15-degree bend, or no angle at all. The foregoing angles are approximate and typically fall within a range, e.g., within about plus-or-minus about 5-degrees. Thus, an approximately 90-degree bend can be considered to be any bend that falls within about 90-degrees and about 100-degrees. In other embodiments, the angle of the bend ranges from about-10% of the stated angle to about +10% of the stated angle. Thus, an approximately 90-degree bend may range between about 81-degrees to about 99-degrees, while an approximately 15-degree bend may range between about 10-degrees to about 20-degrees (e.g., +/−5-degrees), or between about 13.5-degrees (−10%) to about 16.5-degrees (+10%).

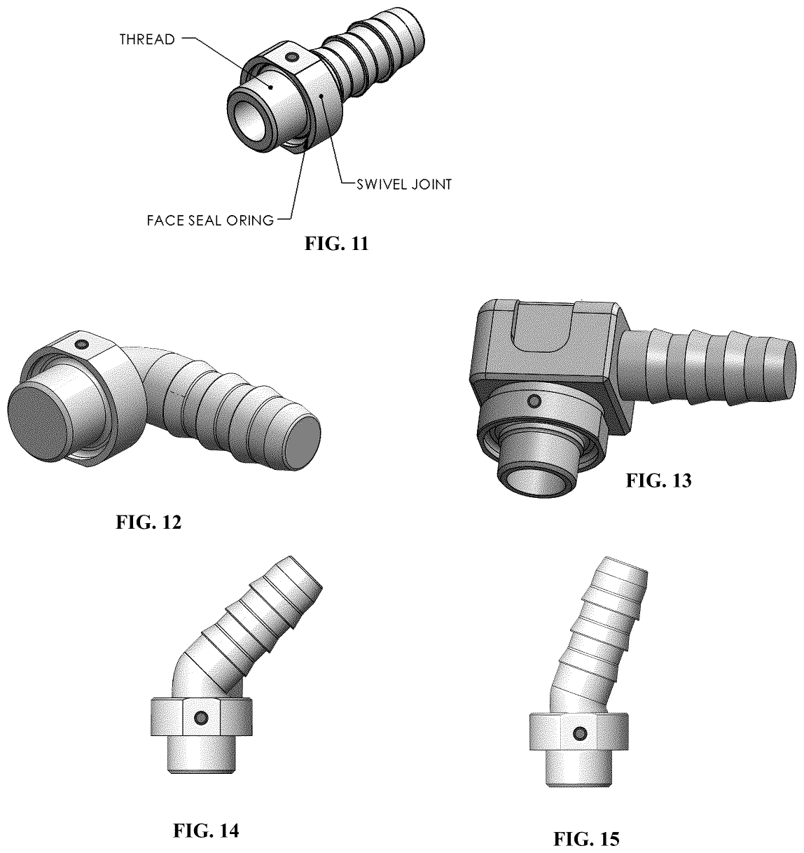

Some swivel joints as just described are assembled before the swivel connector is physically coupled with a component or a conduit. In such embodiments, the swivel connection between the conduit coupler and the component coupler may make seating the threaded stud of the component coupler in a complementary threaded recess of a component (e.g., a cold plate housing) difficult. In such embodiments, an external surface of the component coupler may define one or more faces suitable for engaging with a tool. For instance, an outer surface positioned radially outward of the O-ring 430 in FIG. 4 can define one or more flat surfaces 440 to allow an open-end wrench or a box-wrench to find purchase on the component coupler to allow an installer to apply a torque to the component coupler sufficient to seat the threaded stud in a threaded recess. In other embodiments, e.g., as with the embodiment shown in FIG. 4, the conduit coupler 420 can define a transverse bore 450 or slot or groove and the component coupler 410 can define a complementary bore 455 or slot or groove that is alignable with the bore 450 or slot or groove defined by the conduit coupler 420. When the respective bores 450, 455, slots or grooves of the component coupler 410 and the conduit coupler 420 align with each other, a transversely oriented pin 460, bar or rod can be inserted into the respective bores 450, 455, slots or grooves of the component coupler and the conduit coupler. The pin, bar or rod so inserted as indicated by the arrow 465 showing the pin insertion in FIG. 4 can inhibit or prevent angular displacement between the component coupler 410 and the conduit coupler 420, allowing a torque applied to the conduit coupler to be transmitted to the component coupler during assembly. Accordingly, an outer surface of the conduit coupler 420 can define a tool-engagement region, e.g., one or more opposed flat surfaces 440 (e.g., FIG. 6) suitable for an open-end wrench or a box wrench to gain torsional purchase on the conduit coupler. In other embodiments, a distal surface 429 of the conduit coupler can define a recess having any suitable internal features to provide such torsional purchase, e.g., a hexagonal recess, a Philips-shaped recess, or a Torx-shaped recess. In other embodiments, as FIG. 7 depicts, a conduit coupler can define a recessed face 440a for a tool engagement and an internal shoulder can define a bearing surface for such a tool to retain the conduit coupler to enhance automated assembly with a conduit, a corresponding component coupler as shown in FIGS. 4 and 5, or a component in which such component coupler may be threaded. FIGS. 11 to 15 show embodiments of fluid couplers having internal swivel joints and holes, grooves, or bores for pins or rods as just described.

One or both of the component coupler 410 and the conduit coupler 420 can be fabricated using an additive process (e.g., a so-called “3-D printing” process), a subtractive process (e.g., a so-called machining process, including a milling process, a lathe or other turning process), or a forming process, e.g., a molding process, including by way of example an injection-molding process. In some embodiments, the press-fit connection 401 arises through a combined heating and cooling process, e.g., a component to be inserted into another component (e.g., the distal end of the component coupler shown in FIG. 5) can be cooled and a component to receive the other component (e.g., the proximal end of the conduit coupler shown in FIG. 5) can be heated. Such cooling can cause the component to be inserted to contract and such heating can cause the component to receive the other component to expand. Such complementary changes in dimensions through thermal contraction and expansion can facilitate the press-fitting assembly process. In some injection molding embodiments, parting lines can be avoided or eliminated from sealing surfaces using a molding process as described for example in co-pending U.S. patent application Ser. No. 17/689,879, filed Mar. 8, 2022, the contents of which are hereby incorporated by reference as fully as if reproduced entirely herein, for all purposes.

The previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

Several examples of fluidic devices and systems that can benefit from embodiments of disclosed principles include liquid cooling systems for electronics, two-phase cooling systems for electronics, single-phase and two-phase HVAC systems for buildings, water-distribution systems for agriculture, chemical distribution systems for industrial process. The foregoing examples are selected simply to illustrate the wide variety of applications for disclosed principles; the list of examples is not and is not intended to be exhaustive.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of fluid couplers and fluid connectors, and related systems and methods that can be devised using the various concepts described herein.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

The appended claims are not intended to be limited to the embodiments shown herein but are to be accorded the full scope consistent with the language of the claims, wherein reference to a feature in the singular, such as by use of the article “a” or “an” is not intended to mean “one and only one” unless specifically so stated, but rather “one or more”. Further, in view of the many possible embodiments to which the disclosed principles can be applied, we reserve the right to claim any and all combinations of features and technologies described herein as understood by a person of ordinary skill in the art, including the right to claim, for example, all that comes within the scope and spirit of the foregoing description, as well as the combinations recited, literally and equivalently, in any claims presented anytime throughout prosecution of this application or any application claiming benefit of or priority from this application, and more particularly but not exclusively in the claims appended hereto.

1. A fluid coupler having a swivel joint, the fluid coupler comprising:
a component coupler extending from a first end to a second end and defining an internal bore extending from the first end to the second end, the internal bore of the component coupler having a longitudinal axis,
wherein the component coupler defines a component coupling adjacent the first end, the component coupling being configured to matingly engage with another component to secure the fluid coupler with the other component and to fluidically couple the internal bore of the component coupler with a corresponding internal passageway defined by the other component,
wherein the component coupler defines a first portion of a press or snap fit coupling positioned adjacent the second end;
a conduit coupler extending from a first end to a second end and defining an internal bore extending from the first end to the second end, the internal bore of the conduit coupler having a longitudinal axis,
wherein the conduit coupler defines a conduit coupling adjacent the second end of the conduit coupler, the conduit coupling being configured to matingly engage with a conduit to secure the fluid coupler with the conduit and to fluidically couple the internal bore of the conduit coupler with a corresponding internal passageway defined by the conduit,
wherein the conduit coupler defines a second portion of the press or snap fit coupling adjacent the first end of the conduit coupler; and
a sealing member, wherein the first portion of the press or snap fit coupling and the second portion of the press or snap fit coupling are pressed or snap fit together to define the swivel joint, wherein the sealing member is so positioned as to inhibit leakage of a fluid from the swivel joint.

2. The fluid coupler according to claim 1, wherein the internal bore of the component coupler aligns with the internal bore of the conduit coupler across the swivel joint of the fluid coupler.

3. The fluid coupler according to claim 1, wherein the component coupling comprises a piston configured to extend into the other component and a recessed groove configured to receive a pin to capture the piston within the other component.

4. The fluid coupler according to claim 1, wherein the component coupling defines a threaded region configured to matingly engage with a complementary thread defined by the other component.

5. The fluid coupler according to claim 1, wherein the component coupling defines a piston defining the first end of the component coupler.

6. The fluid coupler according to claim 5, wherein the component coupling further defines a channel positioned between the first end of the component coupler and the second end of the component coupler, wherein the sealing member is a first sealing member and the channel is configured to capture a second sealing member between the component coupler and the other component when the fluid coupler is secured with the other component.

7. The fluid coupler according to claim 6, wherein the channel positioned between the first end of the component coupler and the second end of the component coupler is an annular recess extending around the component coupler.

8. The fluid coupler according to claim 6, wherein one or both of the first sealing member and the second sealing member is an O-ring.

9. The fluid coupler according to claim 1, wherein one of the first portion of the press or snap fit coupling and the second portion of the press or snap fit coupling comprises an external shoulder and wherein the other one of the first portion of the press or snap fit coupling and the second portion of the press or snap fit coupling comprises an internal shoulder.

10. The fluid coupler according to claim 9, wherein the one of the first portion of the press or snap fit coupling and the second portion of the press or snap fit coupling that comprises the external shoulder further defines an external tapered surface extending from the external shoulder.

11. The fluid coupler according to claim 9, wherein the one of the first portion of the press or snap fit coupling and the second portion of the press or snap fit coupling that comprises the internal shoulder further defines an internal tapered surface extending from the internal shoulder.

12. The fluid coupler according to claim 9, wherein the other one of the first portion of the press or snap fit coupling and the second portion of the press or snap fit coupling that comprises the internal shoulder defines an internal channel defining the internal shoulder, wherein the external shoulder is positioned in the internal channel with the external shoulder and the internal shoulder being in opposed relation to each other.

13. The fluid coupler according to claim 12, wherein the sealing member is captured in the channel and urges against corresponding regions of the first portion of the press or snap fit coupling and the second portion of the press or snap fit coupling.

14. The fluid coupler according to claim 13, wherein the sealing member is an O-ring.

15. The fluid coupler according to claim 1, wherein the conduit coupling defines a barbed connection for securing conduit with the fluid coupler.

16. A heat-transfer component, comprising:
a housing defining an inlet, an outlet, and a passageway for conveying fluid from the inlet to the outlet;
a heat-transfer interface configured to be placed in thermal contact with a heat-generating component, wherein a segment of the passageway extends across a portion of the heat-transfer interface to facilitate transfer of heat from the heat-generating component to the fluid passing through the segment of the passageway; and
a fluid coupler having a first portion fixedly secured with the housing, the first portion defining an internal bore opening to the inlet or the outlet defined by the housing, wherein the fluid coupler has a second portion defining an internal bore aligned with the internal bore of the first portion, the fluid coupler defining a swivel joint between the first portion and the second portion to permit the second portion to pivot relative to the first portion, the fluid coupler further having a sealing member within the swivel joint to inhibit leakage of the fluid from the swivel joint.

17. The heat-transfer component according to claim 16, wherein the first portion defines a first threaded region and wherein the housing defines a corresponding second threaded region matingly engaged with the first threaded region to fixedly secure the first portion of the fluid coupler with the housing.

18. A liquid cooling system for cooling a heat-generating component, the liquid cooling system comprising:
a pump configured to urge a liquid coolant through the liquid cooling system;
a cold plate having an internal passageway configured to convey the liquid coolant through the cold plate and to facilitate heat transfer from the heat-generating component to the liquid coolant as the liquid coolant passes through the cold plate;
a first conduit defining an internal passageway configured to convey the liquid coolant to the cold plate and a second conduit defining an internal passageway configured to convey the liquid coolant from the cold plate; and
a fluid coupler having a first portion fixedly secured with the cold plate, the first portion defining an internal bore opening to internal passageway of the housing, wherein the fluid coupler has a second portion defining an internal bore aligned with the internal bore of the first portion, the fluid coupler defining a swivel joint between the first portion and the second portion to permit the second portion to pivot relative to the first portion, the fluid coupler further having a sealing member within the swivel joint to inhibit leakage of the fluid from the swivel joint, wherein one of the first conduit and the second conduit is so coupled with the second portion of the fluid coupler as to align the respective internal passageway with the internal bore of the second portion; and
a heat exchanger configured to reject heat absorbed by the liquid coolant in the cold plate to another medium.

19. The liquid cooling system according to claim 18, wherein the first portion defines a first threaded region and wherein the cold plate defines a corresponding second threaded region matingly engaged with the first threaded region to fixedly secure the first portion of the fluid coupler with the cold plate.

20. The liquid cooling system according to claim 18, wherein the swivel joint comprises a press or snap fit connection between the first portion of the fluid coupler and the second portion of the fluid coupler.
